(19) United States
(12) Patent Application Publication
(10) Pub. No.: US 2006/0209165 A1
(43) Pub. Date: Sep. 21, 2006

(54) Exposure apparatus

(75) Inventor: Kazunobu Ohkubo, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/377,729

(22) Filed: Mar. 17, 2006

(30) Foreign Application Priority Data
Mar. 17, 2005 (JP) 077442/2005

(51) Int. Cl. B41J 2/435

(52) U.S. Cl. 347/224

(57) ABSTRACT

In an exposure apparatus, n (n: integer, n≧2) rows of line-shaped light sources including light emitting elements are arranged in a movement direction of a photosensitive material. When a distance between the centers of recorded pixels is P, if the order of light emission by the light sources is in the movement direction of the photosensitive material, a distance Lᵢ between the centers of adjacent light sources satisfies the following equation:
L₁={kᵢ+(½)·(tᵢ+tᵢ₊₁)/T}·P
(i: integer, 1≦i≦n−1, kᵢ: integer, kᵢ≧1, tᵢ: exposure time of a light source in an i-th row, and T: Σtᵢ₊₁). If the order of light emission is in a direction opposite to the movement direction, a distance L₁ satisfies the following equation:
   L₁={kᵢ−(½)·(tᵢ+tᵢ₊₁)/T}·P.

### BACKGROUND OF THE INVENTION

1. Field of the Invention

The present invention relates to an exposure apparatus for recording an image on a photosensitive recording material by exposing the photosensitive recording material to light emitted from a plurality of light emitting elements.

2. Description of the Related Art

Conventionally, an exposure apparatus for recording an image on a photosensitive material (photosensitive recording material) by exposing the photosensitive material to light emitted from a plurality of line-shaped light sources is well known. The exposure apparatus includes the plurality of line-shaped light sources, in each of which a plurality of light emitting elements is arranged, and a drive circuit for controlling the luminance of light emitted by each of the plurality of light emitting elements and exposure time thereof.

In the exposure apparatus as described above, a plurality of line-shaped light sources is arranged in a movement direction of the photosensitive material. The plurality of line-shaped light sources sequentially emits light while relatively moving with respect to the photosensitive material. Therefore, the positions of pixels recorded on the photosensitive material are shifted by a distance of movement of the photosensitive material during exposure by each of the plurality of line-shaped light sources. Therefore, a technique for preventing shifting of the positions of pixels is well known, for example, as disclosed in U.S. Pat. No. 6,930,699. In U.S. Pat. No. 6,930,699, an interval between adjacent line-shaped light sources is regulated in consideration of timing of light emission by each of the line-shaped light sources.

However, if a line-shaped light source formed by light emitting elements which have low light emission efficiency is present among the plurality of line-shaped light sources, an image which has imbalanced color is recorded, and the image quality deteriorates. Further, if voltage or electric current supplied to the light emitting elements which have low light emission efficiency is increased so as to adjust the color balance of the image, for example, consumption of electric power by the exposure apparatus increases.

Further, if the exposure time of the light emitting elements which have low light emission efficiency is increased so as to adjust the color balance of the image, timing of light emission by the other light emitting elements is shifted. Therefore, the positions of the pixels are shifted. The invention disclosed in U.S. Pat. No. 6,930,699 is effective only when the exposure time of each of the line-shaped light sources is the same. Therefore, it was impossible to solve the problem as described above.

### SUMMARY OF THE INVENTION

In view of the foregoing circumstances, it is an object of the present invention to provide an exposure apparatus which prevents shifting of the positions of pixels by setting an interval between adjacent line-shaped light sources based on exposure time of each of the plurality of line-shaped light sources.

An exposure apparatus according to the present invention is an exposure apparatus for recording an image on a photosensitive recording material by exposing the photosensitive recording material to light emitted from a plurality of light emitting elements, the apparatus comprising:

n (n is an integer greater than or equal to 2) rows of line-shaped light sources which are arranged in a movement direction of the photosensitive recording material, and in each of which the plurality of light emitting elements is arranged in a direction substantially perpendicular to the movement direction of the photosensitive recording material, wherein when a distance between the centers of pixels recorded on the photosensitive recording material by sequential emission of light from the line-shaped light sources is P, if an order of light emission by the line-shaped light sources is in the same direction as the movement direction of the photosensitive recording material, a distance L₁ between the centers of the line-shaped light sources adjacent to each other satisfies the following equation:
L₁={kᵢ+(½)·(tᵢ+tᵢ₊₁)/T}·P

(where i is an integer satisfying 1≦i≦n−1, kᵢ is an integer greater than or equal to 1, tᵢ is exposure time of a line-shaped light source in an i-th row, and T is Σtᵢ₊₁), and wherein if the order of light emission by the line-shaped light sources is in a direction opposite to the movement direction of the photosensitive recording material, a distance L₁ between the centers of the line-shaped light sources adjacent to each other satisfies the following equation:
L₁={kᵢ−(½)·(tᵢ+tᵢ₊₁)/T}·P.

Here, the expression “the order of light emission by the line-shaped light sources is in the same direction as the movement direction of the photosensitive recording material” refers to that the plurality of line-shaped light sources is sequentially turned on so that light emission thereby follows the moving photosensitive recording material. Further, the expression “the order of light emission by the line-shaped light sources is in a direction opposite to the movement direction of the photosensitive recording material” refers to that the plurality of line-shaped light sources is sequentially turned on in a direction opposite to the movement direction of the photosensitive recording material.

An exposure apparatus according to the present invention is an exposure apparatus for recording an image on a photosensitive recording material by exposing the photosensitive recording material to light emitted from a plurality of light emitting elements, the apparatus comprising:

three rows of line-shaped light sources which are arranged in a movement direction of the photosensitive recording material, and in each of which the plurality of light emitting elements is arranged in a direction substantially perpendicular to the movement direction of the photosensitive recording material, wherein exposure time of a line-shaped light source at the center of the line-shaped light sources is q times (q is a positive number) longer than that of each of the other line-shaped light sources, and wherein when a distance between the centers of pixels recorded on the photosensitive recording material by sequential emission of light from the line-shaped light sources is P, if the order of light emission by the line-shaped light sources is in the same direction as the movement direction of the photosensitive recording material, a distance L between the centers of the line-shaped light sources adjacent to each other satisfies the following equation:
L={k+(½)·(q+1)/(q+2)}·P

(where k is an integer greater than or equal to 1), and wherein if the order of light emission by the line-shaped light sources is in a direction opposite to the movement direction of the photosensitive recording material, a distance L between the centers of the line-shaped light sources adjacent to each other satisfies the following equation:
L={k−(½)·(q+1)/(q+2)}·P.

Further, in an exposure apparatus according to the present invention, at least one of the plurality of line-shaped light sources may emit light which has a different hue from the other line-shaped light sources.

Further, in an exposure apparatus according to the present invention, each of the plurality of line-shaped light sources may emit light which has a different hue from each other.

According to the present invention, an exposure apparatus for recording an image on a photosensitive recording material by exposing the photosensitive recording material to light emitted from a plurality of light emitting elements includes n (n is an integer greater than or equal to 2) rows of line-shaped light sources which are arranged in a movement direction of the photosensitive recording material. In each of the line-shaped light sources, the plurality of light emitting elements is arranged in a direction substantially perpendicular to the movement direction of the photosensitive recording material. When a distance between the centers of pixels recorded on the photosensitive recording material by sequential emission of light from the line-shaped light sources is P, if the order of light emission by the line-shaped light sources is in the same direction as the movement direction of the photosensitive recording material, a distance L₁ between the centers of the line-shaped light sources adjacent to each other satisfies the following equation:
L₁={kᵢ+(½)·(tᵢ+tᵢ₊₁)/T}·P

(where i is an integer satisfying 1≦i≦n−1, kᵢ is an integer greater than or equal to 1, tᵢ is exposure time of a line-shaped light source in an i-th row, and T is Σtᵢ₊₁). If the order of light emission by the line-shaped light sources is in a direction opposite to the movement direction of the photosensitive recording material, a distance L₁ between the centers of the line-shaped light sources E adjacent to each other satisfies the following equation:
L₁={kᵢ−(½)·(tᵢ+tᵢ₊₁)/T}·P.

Therefore, even if the exposure time of each of the line-shaped light sources is different from each other, it is possible to prevent shifting of the positions of pixels recorded on the photosensitive recording material.

Conventionally, if a line-shaped light source including light emitting elements which have low light emission efficiency is present among the plurality of line-shaped light sources, an image which has imbalanced color is recorded, and the image quality deteriorates. However, if the exposure time of the line-shaped light source including the light emitting elements which have low light emission efficiency is set longer than that of other line-shaped light sources, and if a distance between the centers of the line-shaped light sources adjacent to each other is set based on the above equations, it is possible to adjust the color balance of the image without causing shift of the positions of the pixels recorded on the photosensitive material. Hence, it is possible to improve the image quality.

### BRIEF DESCRIPTION OF THE DRAWINGS

FIG. 1 is a partial sectional view illustrating the structure of an exposure apparatus, from the front side thereof;

FIG. 2 is a partial sectional view illustrating the structure of the exposure apparatus, from the side thereof;

FIG. 3A is a diagram illustrating the relationship between the timing of light emission by each of line-shaped light sources and the positions of pixels in a first embodiment of the present invention;

FIG. 3B is a diagram illustrating the relationship between the timing of light emission by each of line-shaped light sources and the positions of pixels in the first embodiment of the present invention;

FIG. 3C is a diagram illustrating the relationship between the timing of light emission by each of line-shaped light sources and the positions of pixels in the first embodiment of the present invention;

FIG. 3D is a diagram illustrating the relationship between the timing of light emission by each of line-shaped light sources and the positions of pixels in the first embodiment of the present invention;

FIG. 3E is a diagram illustrating the relationship between the timing of light emission by each of line-shaped light sources and the positions of pixels in the first embodiment of the present invention;

FIG. 3F is a diagram illustrating the relationship between the timing of light emission by each of line-shaped light sources and the positions of pixels in the first embodiment of the present invention;

FIG. 4 is a diagram for explaining the arrangement positions of line-shaped light sources in a second embodiment of the present invention;

FIG. 5A is a diagram for explaining the positions of pixels recorded by each of the line-shaped light sources in the second embodiment of the present invention;

FIG. 5B is a diagram for explaining the positions of pixels recorded by each of the line-shaped light sources in the second embodiment of the present invention; and

FIG. 5C is a diagram for explaining the positions of pixels recorded by each of the line-shaped light sources in the second embodiment of the present invention.

### DESCRIPTION OF THE PREFERRED EMBODIMENTS

Hereinafter, an exposure apparatus according to the present invention will be described in detail with reference to the attached drawings.

### Embodiment 1

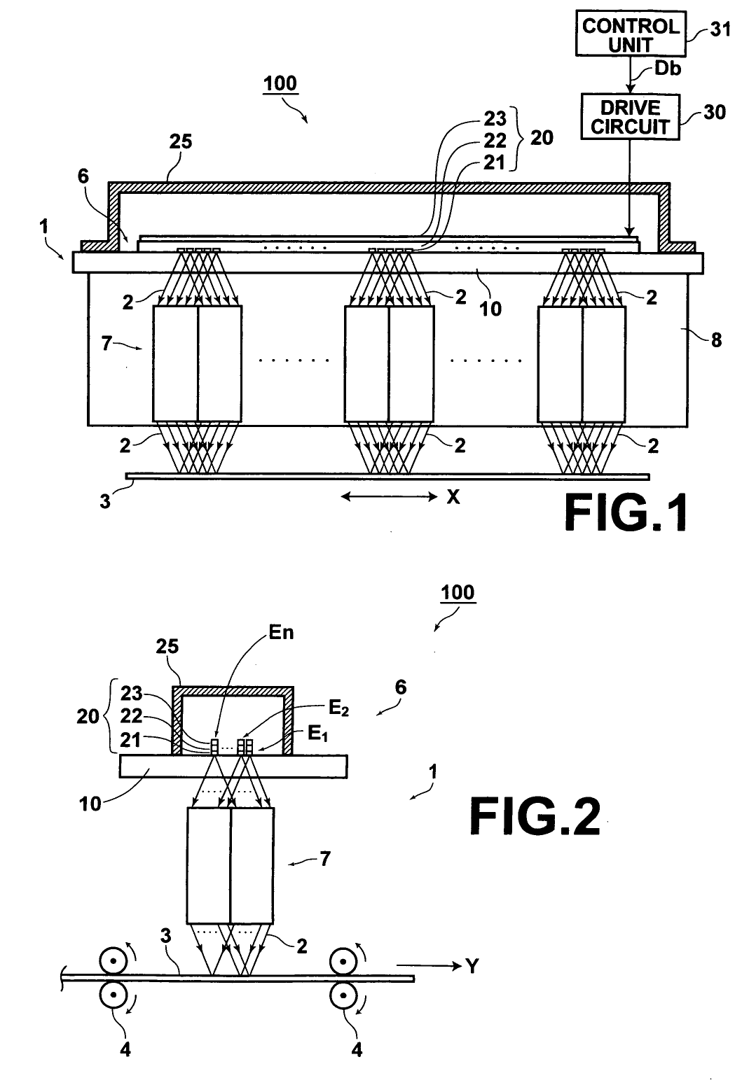

FIG. 1 is a partial sectional view of an exposure apparatus 100 according to a first embodiment of the present invention. In FIG. 1, the structure of the exposure apparatus 100 viewed from the front side thereof is illustrated. FIG. 2 is a partial sectional view of the exposure apparatus 100. In FIG. 2, the structure of the exposure apparatus 100 viewed from the side thereof is illustrated. The exposure apparatus 100 includes an exposure head 1 and a sub-scan means 4. The sub-scan means 4 conveys a photosensitive material (photosensitive recording material) 3 at constant speed in a direction of an arrow Y illustrated in FIG. 2. The photosensitive material 3 is held at a position illuminated with exposure light 2 emitted from the exposure head 1. The exposure head 1 includes an organic EL (electroluminescence) element panel 6, a lens array 7 and a holding means 8 (not illustrated in FIG. 2). The holding means 8 holds the organic EL element panel 6 and the lens array 7. The lens array 7 is arranged at a position at which the exposure light 2 emitted from the organic EL element panel 6 is received. The lens array 7 forms an image on the photosensitive material 3 with the exposure light 2. The image is formed at the same size as that of a received image.

The exposure apparatus 100 according to the present embodiment exposes the photosensitive material 3 to light to form a color image thereon. In the organic EL element panel 6 included in the exposure head 1, a plurality of organic EL elements 20 is arranged adjacent to each other in a direction substantially perpendicular to a movement direction (direction of the arrow Y in FIG. 2) of the photosensitive material 3. The plurality of organic EL elements 20 emits light which has the same hue. The plurality of organic EL elements 20 forms a line-shaped light source E₁. Further, line-shaped light sources E₁, E₂, . . . , Eₙ (n is an integer greater than or equal to 2, and hereinafter, the line-shaped light sources are comprehensively referred to as “line-shaped light sources E”) are arranged in the movement direction of the photosensitive material 3. Each of the line-shaped light sources E is formed in a manner similar to the line-shaped light source E₁. Among the plurality of line-shaped light sources E, at least one of the line-shaped light sources E may emit light which has a different hue from the other line-shaped light sources E. Alternatively, each of the plurality of line-shaped light sources E may emit light which has a different hue from each other.

Further, in the present embodiment, the organic EL elements are used as the light emitting elements. However, the light emitting element is not limited to the organic EL element. For example, an inorganic EL element, a light emitting diode (LED), an element, such as liquid crystal and PLZT (lead lanthanum zirconate titanate), which is formed by combining a light control element and a light source, or the like may be adopted as the light emitting element. The organic EL element 20 is formed by laying a transparent positive pole 21, an organic compound layer 22 including a light emitting layer and a metal negative pole 23 on a transparent base plate (substrate) made of glass or the like by vapor deposition.

Each of the line-shaped light sources E is driven by a drive circuit 30 illustrated in FIG. 1. The drive circuit 30 includes a negative pole driver and a positive pole driver. The negative pole driver sequentially sets the metal negative pole 23, which operates as a scanning electrode, to a selected state in a predetermined cycle. The positive pole driver applies a graduation voltage, based on image data Db, to the transparent positive pole 21. The line-shaped light sources E are driven by using a so-called passive matrix line-sequential-selection drive method. Further, the operation of the drive circuit 30 is controlled by a control unit 31 which outputs the image data Db.

The organic EL elements 20 are placed in a seal member 25 such as a stainless can, for example. Specifically, an edge of the seal member 25 is attached to the transparent base plate 10, and the organic EL elements 20 are placed in the seal member 25 which is filled with dry nitrogen gas.

In the organic EL element 20 structured as described above, when a voltage is applied between the metal negative pole 23 and the transparent positive pole 21 which extends to cross the metal negative pole 23, an electric current flows into the organic compound layer 22 at the intersection of the transparent positive pole 21 and the metal negative pole 23 to which the voltage has been applied. Then, a light emitting layer included in the organic compound layer 22 emits light. The emitted light is transmitted through the transparent positive pole 21 and the transparent base plate 10, and emitted as exposure light 2.

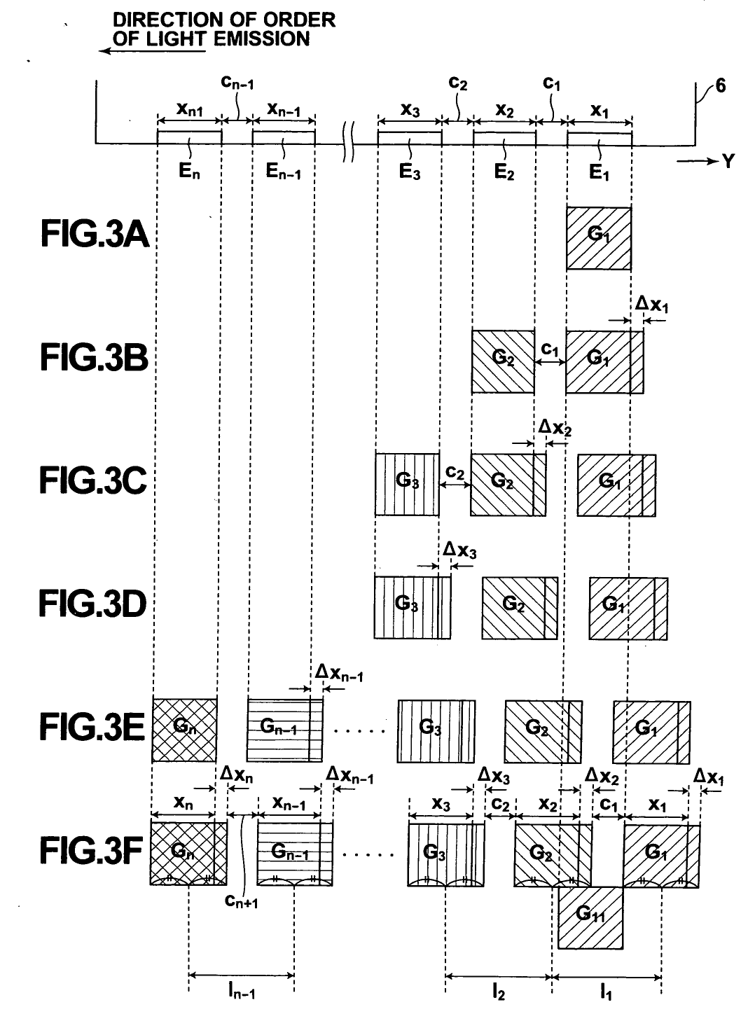

Next, the operation of the exposure apparatus 100 will be described. FIGS. 3A through 3F are diagrams illustrating the relationship between the timing of light emission by each of the line-shaped light sources E and the positions of pixels. In FIGS. 3A through 3F, the exposure head 1 is viewed in a direction parallel to a main scan direction. In the exposure head 1, line-shaped light sources E₁, E₂, . . . , Eₙ₋₁, Eₙ are arranged in the movement direction (direction of the arrow Y) of the photosensitive material 3. The length of each of the line-shaped light sources E with respect to a sub-scan direction is x₁, x₂, . . . , xₙ, respectively. Further, an interval between adjacent line-shaped light sources E is c₁, c₂, . . . , cₙ, respectively.

First, a metal negative pole 23 of the line-shaped light source E₁ is set to a selected state by the negative pole driver of the drive circuit 30. Then, the positive pole driver of the drive circuit 30 applies a gradation voltage based on image data Db to each of metal positive poles 21. Accordingly, light which has luminance based on the gradation voltage is emitted from each of the organic compound layers 22, and the light is emitted from the exposure head 1 as exposure light 2. Then, an image is formed with the exposure light 2, emitted from the exposure head 1, by the lens array 7. Then, the photosensitive material 3 is illuminated with the exposure light 2. In FIG. 3A, a pixel G₁, which was recorded immediately after the line-shaped light source E₁ started exposure, is illustrated. In FIGS. 3A through 3F, pixels G₁, G₂, . . . , Gₙ, each corresponding to a single organic EL element 20, are illustrated as pixels recorded by each of the line-shaped light sources E so as to simplify explanation. The pixel G₁ is recorded along the movement direction of the photosensitive material 3, and the length of the pixel G₁ with respect to the movement direction of the photosensitive material 3 is x₁.

The exposure light 2 from the line-shaped light source E₁ is emitted for exposure time t₁. Since the exposure head 1 and the photosensitive material 3 constantly move relative to each other, the length of the pixel G₁ with respect to the movement direction of the photosensitive material 3 becomes longer by a distance Δx₁ (please refer to FIG. 3B) after time t₁. The distance Δx₁ is a distance of movement by the photosensitive material 3 in time t₁.

When the line-shaped light source E₁ ends exposure, a metal negative pole 23 of the line-shaped light source E₂ is selected by the negative pole driver of the drive circuit 30. Then, the positive driver of the drive circuit 30 applies a gradation voltage based on image data Db to each of metal positive poles 21. Accordingly, light which has luminance based on the gradation voltage is emitted from each of organic compound layers 22, and the light is emitted from the exposure head 1 as exposure light 2. In FIG. 3B, a pixel G₂, which was recorded immediately after the line-shaped light source E₂ started exposure, is illustrated. The pixel G₂ is recorded at a position spaced apart from the pixel G₁ in the movement direction of the photosensitive material 3. The pixel G₁ and the pixel G₂ are apart from each other by an interval c₁ between the line-shaped light source E₁ and the line-shaped light source E₂.

The exposure light 2 is emitted from the line-shaped light source E₂ for exposure time t₂. Since the exposure head 1 and the photosensitive material 3 constantly move relative to each other, the length of the pixel G₂ in the movement direction of the photosensitive material 3 becomes longer by a distance Δx₂ (please refer to FIG. 3C) after time t₂. The distance Δx₂ is a distance of movement by the photosensitive material 3 in time t₂. When the line-shaped light source E₂ ends exposure, a metal negative pole 23 of the line-shaped light source E₃ is selected by the negative pole driver of the drive circuit 30. Then, exposure light 2 is emitted from the line-shaped light source E₃, and a pixel G₃ is recorded. The pixel G₃ is recorded at a position spaced apart from the pixel G₂ in the movement direction of the photosensitive material 3. The pixel G₂ and the pixel G₃ are apart from each other by an interval c₂ between the line-shaped light source E₂ and the line-shaped light source E₃. Then, exposure light 2 is sequentially emitted from the line-shaped light source E₄ through the line-shaped light source Eₙ in a similar manner, and pixels are recorded.

When the line-shaped light source Eₙ ends exposure, the line-shaped light source E₁ starts exposure again, and a pixel G₁₁ is recorded, as illustrated in FIG. 3F. The pixel G₁₁ is actually recorded at a position on the left side of the pixel G₁ in FIG. 3F. However, in FIG. 3F, the pixel G₁₁ is illustrated at a lower position so as to represent the passage of time. Then, the operation as described above is repeated for the line-shaped light sources E₂ through Eₙ.

Here, if organic EL elements 20 which have lower light emission efficiency than other organic EL elements 20 are present among the organic EL elements 20 included in the line-shaped light sources E, the color balance of an image recorded on the photosensitive material 3 deteriorates, and the image quality drops.

As a method for adjusting the color balance of the image which will be recorded on the photosensitive material 3, there is a method for adjusting the exposure time of the line-shaped light source E including the organic EL elements 20 which have lower light emission efficiency. However, if different exposure time is set for some of the line-shaped light sources E, the positions of pixels are shifted. For example, in FIGS. 3A through 3F, if the exposure time t₃ of the line-shaped light source E₃ is longer than that of each of the other line-shaped light sources E, the position of the pixel G₁₁ is shifted with respect to the pixel G₂, or the like. Therefore, the positions of pixels which have different colors are shifted from each other.

However, if a distance between the centers of the line-shaped light sources E adjacent to each other is set based on the exposure time of each of the line-shaped light sources E, even if the exposure time of each of the line-shaped light sources E is different from each other, it is possible to prevent shifting of the positions of the pixels. Further, a method for calculating the distance between the centers of the line-shaped light sources E adjacent to each other based on the exposure time of each of the line-shaped light sources E will be described below.

If a pixel pitch of pixels (pixels corresponding to the resolution of image data) recorded on the photosensitive material 3 with respect to the movement direction of the photosensitive material 3 is P, a movement speed of the photosensitive material 3 is v, and exposure time (length of time from the start of exposure by the line-shaped light source E₁ to the end of exposure by the line-shaped light source Eₙ) for one cycle is T, the following equation is satisfied:
P=v·T (1).

Further, since exposure is performed by sequentially emitting light from n rows of line-shaped light sources E, if exposure time of each of the line-shaped light sources E is tᵢ (i is an integer satisfying 1≦i≦n−1), the following equation is satisfied:
T=Σtᵢ₊₁ (2).

Further, a distance Δx₁ of movement of the photosensitive material 3 in the exposure time t₁ of the line-shaped light source E₁ satisfies the following equation:
Δx₁=(t₁/T)·P (3).

Further, a distance Δx₂ of movement of the photosensitive material 3 in the exposure time t₂ of the line-shaped light source E₂ satisfies the following equation:
Δx₂=(t₂/T)·P (4).

Here, if the distance between the centers of the pixel G₁ and the pixel G₂ is l₁, the following equation is satisfied:
l₁={(x₁+Δx₁)/2}+c₁+{(x₂+Δx₂)/2} (5)

If the equations (3) and (4) are substituted into the equation (5), the following equation is obtained:
l₁=[x₁+{(t₁/T)·P}]/2+c₁+[x₂+{(t₂/T)·P}]/2={(x₁+x₂)/2}+c₁+{P·(t₁+t₂)}/2T (6).

If the distance between the centers of the line-shaped light source E₁ and the line-shaped light source E₂ is L₁, the following equation is satisfied:
L₁={(x₁+x₂)/2}+c₁ (7).

Therefore, if the equation (7) is substituted into the equation (6), the following equation is obtained:
l₁=L₁+{P·(t₁+t₂)}/2T (8).

Similarly, a distance between other pixels adjacent to each other satisfies the following equation:
lᵢ=L₁+{P·(t₁+tᵢ₊₁)}/2T (9).

Here, it is necessary that the distance between the centers of the line-shaped light sources E is an integral multiple of the pixel pitch P of pixels so as to record the pixels by each of the line-shaped light sources E without shifting the positions of the pixels with respect to the sub-scan direction. Therefore, it is necessary that the following condition is satisfied:
L₁+{P·(t₁+tᵢ₊₁)}/2T=kᵢ·P (10).

Here, kᵢ is a superposition-shift number, and kᵢ is an integer greater than or equal to 1.

The distance Lᵢ between the centers of the line-shaped light sources E is obtained using the equation (10), and the distance Lᵢ is as follows:
Lᵢ={kᵢ−(½)·(tᵢ+tᵢ₊₁)/T}·P (11).

Even if the exposure time by each of the line-shaped light sources is different from each other, if the distance Lᵢ between the centers of the line-shaped light sources E is set so as to satisfy the equation (11), it is possible to prevent shifting of the positions of the pixels recorded on the photosensitive material 3. Here, the equation (11) is applied when the order of light emission by the line-shaped light sources E is in a direction opposite to the movement direction of the photosensitive material 3 (in other words, when the line-shaped light sources E are sequentially turned on in a direction opposite to the movement direction of the photosensitive material 3). If the order of light emission by the line-shaped light sources E is in the same direction as the movement direction of the photosensitive material 3 (in other words, if line-shaped light sources E are sequentially turned on so as to follow the movement of the photosensitive material 3), the following equation (12) is applied:
Lᵢ={kᵢ+(½)·(tᵢ+tᵢ₊₁)/T}·P (12).

As described above, if the distance Lᵢ between the centers of the line-shaped light sources E is calculated using one of the equations (11) and (12) based on the relationship between the light emission order by the line-shaped light sources E and the movement direction of the photosensitive material 3, even if the exposure time by each of the line-shaped light sources E is different from each other, it is possible to prevent shifting of the positions of the pixels recorded on the photosensitive material 3. Conventionally, if a line-shaped light source E including organic EL elements 20 which have low light emission efficiency is present among a plurality of line-shaped light sources E, the color balance of an image recorded on the photosensitive material 3 deteriorates, and the image quality drops. However, if the exposure time of the line-shaped light source E including the organic EL elements 20 which have low light emission efficiency is increased, and if the distance between the centers of the line-shaped light sources E is set using the equation (11) or (12), it is possible to adjust the color balance of the image without shifting the positions of the pixels recorded on the photosensitive material 3. Therefore, it is possible to improve the image quality.

### Embodiment 2

In Embodiment 1, the exposure head 1 includes n rows of line-shaped light sources E. In Embodiment 1, a method for obtaining the distance between the centers of the line-shaped light sources E when the width of each of the line-shaped light sources E in the sub-scan direction is xᵢ, the interval between the adjacent line-shaped light sources E is cᵢ, and the exposure time of each of the line-shaped light sources E is tᵢ was described. In Embodiment 2, the exposure-head 1 includes three rows of line-shaped light sources. In Embodiment 2, a method for calculating the distance between the centers of the line-shaped light sources E when the width of each of all the line-shaped light sources in the sub-scan direction is x, the interval between any pair of adjacent line-shaped light sources is c (same interval), and the exposure time of only the line-shaped light source at the center is three times longer than that of each of the other line-shaped light sources will be described. The structure of the exposure apparatus in Embodiment 2 is the same as that of the exposure apparatus 100 described in Embodiment 1. Therefore, in Embodiment 2, description of the structure of the exposure apparatus will be omitted.

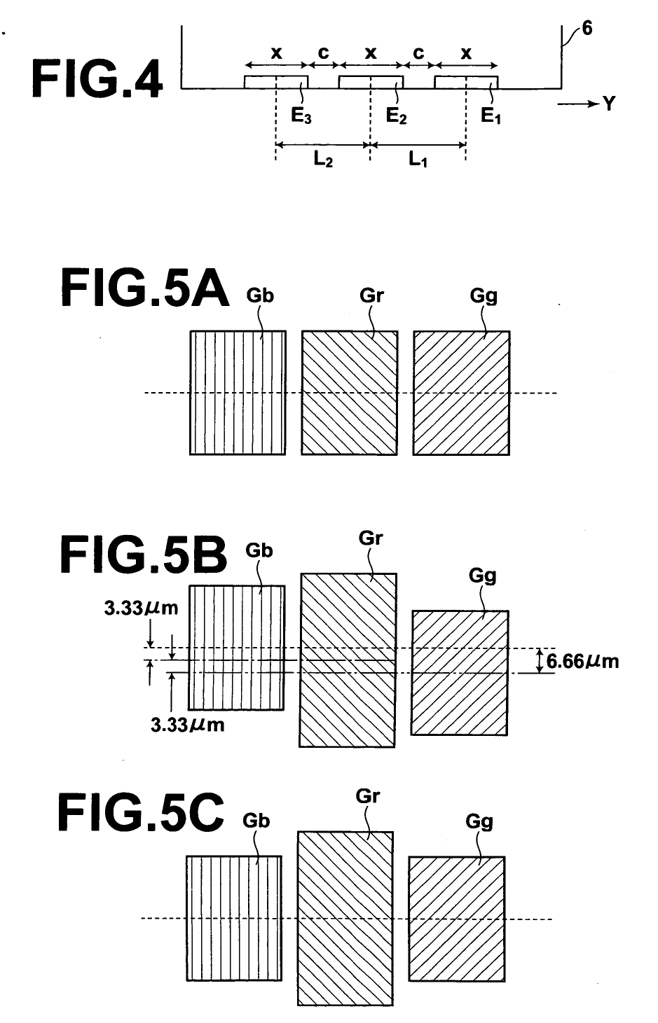

FIG. 4 is a schematic diagram of the exposure head 1 according to the present embodiment. In FIG. 4, the exposure head 1 is viewed in a direction parallel to the main scan direction. In FIG. 4, at least one of the line-shaped light sources E₁ through E₃ (hereinafter, comprehensively referred to as “line-shaped light sources E”) emits light which has a different hue from the other line-shaped light sources. Alternatively, each of the line-shaped light sources E₁ through E₃ emits light which has a different color such as blue, red or green. The length of each of the line-shaped light sources E with respect to the movement direction (direction of the arrow Y in FIG. 4) of the photosensitive material 3 is x, and the interval between the line-shaped light sources E is c.

First, in exposure condition 1, the exposure time t₁, t₂ and t₃ of each of all the line-shaped light sources E is set to t. Then, the distance L between the centers of the line-shaped light sources E under the exposure condition 1 is obtained using the equation (11). For example, if k=2, and P=50 [um], since T=3t, the distance L between the centers of the line-shaped light sources E is obtained as follows:

$$\begin{matrix}L = \{ {k}_{i} - ( 1 / 2 ) \cdot ( {t}_{i} + {t}_{i + 1} ) / T \} \cdot P \\ = \{ 2 - ( 1 / 2 ) \cdot ( 2 t / 3 t ) \} \times 50 \\ = 83.33 [ um ] .\end{matrix} \qquad ( 13 )$$

Next, in exposure condition 2, each of the exposure time t₁ of the line-shaped light sources E₁ and the exposure time t₃ of the line-shaped light sources E₃ is set to t. The exposure time t₂ of the line-shaped light source E₂ is increased to 3t, which is three times longer than that of each of the other line-shaped light sources E. The exposure time t₂ of the line-shaped light source E₂ is increased, for example, because the light emission efficiency of the organic EL elements 20 forming the line-shaped light sources E₂ is lower than that of the organic EL elements 20 forming the line-shaped light source E₂ and E₃. Then, the distance L between the centers of the line-shaped light sources E under the exposure condition 2 is obtained using the equation (11). Since T=t₁+t₂+t₃=5t, if k=2, and P=50 [um], for example, the distance L between the centers of the line-shaped light sources E is obtained as follows:

$$\begin{matrix}{L}_{1} = \{ k - ( 1 / 2 ) \cdot ( {t}_{i} + {t}_{2} ) / T \} \cdot P & ( 14 a ) \\ = \{ 2 - ( 1 / 2 ) \cdot ( 4 t / 5 t ) \} \times 50 & \\ = 80 [ um ] ; & \\ and & \\ {L}_{2} = \{ k - ( 1 / 2 ) \cdot ( {t}_{2} + {t}_{3} ) / T \} \cdot P & ( 14 b ) \\ = \{ 2 - ( 1 / 2 ) \cdot ( 4 t / 5 t ) \} \times 50 & \\ = 80 [ um ] . & \end{matrix}$$

Next, the present embodiment will be described in detail with reference to FIGS. 5A through 5C. FIGS. 5A through 5C illustrate pixels recorded by the line-shaped light sources E. Normally, the pixels are superimposed on each other. However, in FIGS. 5A through 5C, the pixels are shifted from each other in the horizontal direction for the purpose of explanation. In FIGS. 5A through 5C, a pixel G_{b} is a pixel recorded by the line-shaped light source E₁ and a pixel Gᵣ is a pixel recorded by the line-shaped light source E₂. A pixel G_{g} is a pixel recorded by the line-shaped light source E₃. FIG. 5A illustrates each of pixels recorded by performing exposure under the exposure condition 1, as described above, when the distance L between the centers of the line-shaped light sources E is 83.33 [um]. The central position of each of the pixels is the same, and the positions of the pixels are not shifted from each other.

FIG. 5B illustrates each of pixels recorded by performing exposure under the exposure condition 2, as described above, when the distance L between the centers of the line-shaped light sources E is 83.33 [um]. In the exposure condition 2, each of the exposure time t₁ of the line-shaped light source E₁ and the exposure time t₃ of the line-shaped light source E₃ are t, and the exposure time t₂ of the line-shaped light source E₂ is 3t. When exposure is performed under the exposure condition 2, the distance between the centers of the line-shaped light sources E must be 80 [nm] as proved using the equations (14a) and (14b). However, in the example illustrated in FIG. 5B, the distance between the centers of the line-shaped light sources E is set to 83.33 [um] which should be applied when the exposure time of each of the line-shaped light sources is the same. Therefore, the positions of the pixels are shifted from each other. Specifically, the central positions of the pixels G_{b} and Gᵣ are shifted from each other by 3.33 [um], and the central positions of the pixels Gᵣ and G_{g} are shifted from each other by 3.33 [um]. Therefore, the central positions of the pixels G_{b} and G_{g} are shifted from each other by 6.66 [um].

FIG. 5C illustrates each of pixels recorded by performing exposure under the exposure condition 2 when the distance L between the centers of the line-shaped light sources E is 80 [um]. The central position of each of the pixels is the same, and the positions of the pixels are not shifted from each other.

The distance L between the centers of the line-shaped light sources E in the case that the exposure head 1 includes three rows of line-shaped light sources E and that the exposure time of only the line-shaped light source E at the center is three times longer than that of each of the other line-shaped light sources E has been described. When the exposure time of the line-shaped light source E at the center is q times longer than that of each of the other line-shaped light sources E, the distance L between the centers of the line-shaped light sources may be obtained using the following generalized equation:
L={k+(½)·(q+1)/(q+2)}·P (15).

In the equation (15), k is a superposition-shift number, and k is an integer greater than or equal to 1. The equation (15) is applied when the order of light emission by the line-shaped light sources E is in the same direction as the movement direction of the photosensitive material 3 (in other words, line-shaped light sources E are sequentially turned on so as to follow the moving photosensitive material 3). When the order of light emission by the line-shaped light sources E is in a direction opposite to the movement direction of the photosensitive material 3 (in other words, line-shaped light sources E are sequentially turned in a direction opposite to the movement of the photosensitive material 3), the following equation is applied:
L={k−(½)·(q+1)/(q+2)}·P (16).

As described above, when the exposure head 1 includes three rows of line-shaped light sources E and the exposure time of the line-shaped light source E at the center is q times longer than that of each of the other line-shaped light sources E, the distance L between the centers of the line-shaped light sources E is calculated using the equation (15) or (16) based on the light emission order by the line-shaped light sources E and the movement direction of the photosensitive material 3. If the distance L between the centers of the line-shaped light sources E is set to the calculated value, it is possible to prevent shifting of the positions of the pixels recorded on the photosensitive material 3 even if the exposure time of each of the line-shaped light sources is different from each other. Therefore, it is possible to improve the quality of the image recorded on the photosensitive material 3.

What is claimed is:

1. An exposure apparatus for recording an image on a photosensitive recording material by exposing the photosensitive recording material to light emitted from a plurality of light emitting elements, the apparatus comprising:
n (n is an integer greater than or equal to 2) rows of line-shaped light sources which are arranged in a movement direction of the photosensitive recording material, and in each of which the plurality of light emitting elements is arranged in a direction substantially perpendicular to the movement direction of the photosensitive recording material, wherein when a distance between the centers of pixels recorded on the photosensitive recording material by sequential emission of light from the line-shaped light sources is P, if the order of light emission by the line-shaped light sources is in the same direction as the movement direction of the photosensitive recording material, a distance L₁ between the centers of line-shaped light sources adjacent to each other satisfies the following equation:
L₁={kᵢ+(½)·(tᵢ+tᵢ₊₁)/T}·P
(where i is an integer satisfying 1≦i≦n−1, kᵢ is an integer greater than or equal to 1, tᵢ is exposure time of a line-shaped light source in an i-th row, and T is Σtᵢ₊₁), and wherein if the order of light emission by the line-shaped light sources is in a direction opposite to the movement direction of the photosensitive recording material, a distance L₁ between the centers of line-shaped light sources adjacent to each other satisfies the following equation:
L₁={kᵢ−(½)·(tᵢ+tᵢ₊₁)/T}·P.

2. An exposure apparatus for recording an image on a photosensitive recording material by exposing the photosensitive recording material to light emitted from a plurality of light emitting elements, the apparatus comprising:
three rows of line-shaped light sources which are arranged in a movement direction of the photosensitive recording material, and in each of which the plurality of light emitting elements is arranged in a direction substantially perpendicular to the movement direction of the photosensitive recording material, wherein exposure time of a line-shaped light source at the center of the line-shaped light sources is q times (q is a positive number) longer than that of each of the other line-shaped light sources, and wherein when a distance between the centers of pixels recorded on the photosensitive recording material by sequential emission of light from the line-shaped light sources is P, if the order of light emission by the line-shaped light sources is in the same direction as the movement direction of the photosensitive recording material, a distance L between the centers of line-shaped light sources adjacent to each other satisfies the following equation:
L={k+(½)·(q+1)/(q+2)}·P
(where k is an integer greater than or equal to 1), and wherein if the order of light emission by the line-shaped light sources is in a direction opposite to the movement direction of the photosensitive recording material, a distance L between the centers of the line-shaped light sources adjacent to each other satisfies the following equation:
L={k−(½)·(q+1)/(q+2)}·P.

3. An exposure apparatus as defined in claim 1, wherein at least one of the plurality of line-shaped light sources emits light which has a different hue from the other line-shaped light sources.

4. An exposure apparatus as defined in claim 1, wherein each of the plurality of line-shaped light sources emits light which has a different hue from each other.

5. An exposure apparatus as defined in claim 2, wherein at least one of the plurality of line-shaped light sources emits light which has a different hue from the other line-shaped light sources.

6. An exposure apparatus as defined in claim 2, wherein each of the plurality of line-shaped light sources emits light which has a different hue from each other.
